(19) United States
(12) Patent Application Publication
(10) Pub. No.: US 2003/0235707 A1
(43) Pub. Date: Dec. 25, 2003

(54) Resin-coated paper support

(75) Inventor: Toshiaki Aono, Shizuoka-ken (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/411,377

(22) Filed: Apr. 11, 2003

(30) Foreign Application Priority Data
Apr. 11, 2002 (JP) 2002-109113
Jan. 30, 2003 (JP) 2003-21578

(51) Int. Cl. B32B 27/00

(52) U.S. Cl. 428/500; 428/211.1

(57) ABSTRACT

A resin-coated paper support (coated paper) including a resin coating layer on a paper support, in which the resin coating layer contains a water-soluble polymer having a hydrophobic group at a terminal thereof, and a hydrophobic dispersion.

### BACKGROUND OF THE INVENTION

1. Field of the Invention

The present invention relates to a paper support having a resin coating layer (coating layer) and in particular to a coated paper support (coated paper) suitable for imparting of functions such as water resistance, gloss, and toner image receiving properties, which is formed by applying an aqueous dispersion such as a hydrophobic dispersion of pigments, etc. dispersed stably by preventing flocculation.

2. Description of the Related Art

Heretofore, a paper support has often been provided with a resin coating layer (coating layer) thereon in order to endow the paper support with various functions such as water resistance, gloss, toner receiving properties, high resolution, gas barrier properties, curling resistance and coating strength.

Such resin coating layer is usually formed by applying a paper support with a coating solution having a hydrophobic dispersion of pigments, fillers, etc. dispersed therein. The coating solution is preferably an aqueous dispersion from the viewpoint of working environment, safety and costs. However, the aqueous coating solution of a hydrophobic dispersion is generally highly precipitated and flocculated, thus making it difficult to prepare a uniform and stable dispersed coating solution.

For example, there is a need for imparting of water resistance and improving smoothness for a support such as a photographic printing paper, a heat-sensitive paper, an ink jet recording paper and an electrophotographic paper for high qualities (comparative to those of a photograph). For imparting water resistance, a hydrophobic resin latex or emulsion is used; for improving whiteness, etc., a pigment such as titanium dioxide is used; and for improving running and transferability, a lubricant dispersion such as wax is added. Particles in these coating solutions are easily flocculated and thus hardly stably and uniformly dispersed, and flocculates appear as foreign matter protruded from the surface of the support, often resulting in significant deterioration in smoothness and reduction in gloss.

In a process for producing a recording material support thus provided with a water-resistant resin coating layer composed of a hydrophobic latex, emulsion or wax dispersion, there is a strong need for a method of forming a highly gloss, water-resistant resin coating layer without generating flocculates as described above.

Heretofore, hydrophobic dispersions of pigments, etc. exhibiting vivid shades and high coloring power have been used in many fields, and especially, practically important hydrophobic dispersions have particularly fine particles, and by pulverizing the particles, vivid shades and high coloring power can be achieved. However, when hydrophobic dispersions of pigments, etc. are pulverized, their hydrophobic dispersion is often rendered highly viscous. Accordingly, when the hydrophobic dispersion is to be produced and stored in industrial scale, there is a problem that the hydrophobic dispersion is hardly removed from a dispersing machine, cannot be transferred through a pipeline because of an increase in pressure loss, or cannot be used because of precipitation during storage.

To obtain a pigment dispersion or coloring composition excellent in fluidity or dispersibility, use of various dispersants is known. The dispersants are roughly divided into polymer dispersants and low-molecular dispersants. Known examples of the polymer dispersants include polyacrylate, sodium maleate/olefin copolymers, a polyester containing a carboxyl group at a terminal thereof (for example, see Japanese Patent Application Publication (JP-B) No. 54-34009), a polyester having an acidic group and/or a basic group, produced from tetrakis(2-hydroxyalkyl)ethylene diamine as a starting material (for example, see Japanese Patent Application Laid-Open (JP-A) No. 2-245231), and a copolymer consisting of four kinds of monomers, that is, a macro-monomer (oligomer having an ethylenically unsaturated group at a terminal thereof), a monomer having a hydroxyl group, a monomer containing a carboxyl group, and another monomer (for example, see JP-A No. 8-259876). Known examples of the low-molecular dispersants include a sorbitan fatty ester, polyoxyethylene alkylamine, alkyl diamine, an alkanol amine derivative (for example, see U.S. Pat. No. 3,536,510), etc.

Among the dispersants described above, the copolymer containing a macro-monomer (oligomer having an ethylenically unsaturated group at a terminal thereof) is useful for the coloring composition, and it is described that a pigment dispersion having a low pigment particle diameter and excellent in dispersion stability can be obtained by the copolymer containing a macro-monomer having an ethylenically unsaturated group at a terminal thereof (for example, see JP-A Nos. 7-140654, 5-273411, and 8-259876). However, there is a problem that the macro-monomer does not contain a nitrogen atom so that when used as a dispersant, the macro-monomer does not function by itself and thus should be used in combination with another dispersant. The macro-monomer when used as a dispersant is excellent in that the thickening effect observed upon use of high-molecular dispersants is low, but there is a problem that the macro-monomer is insufficient in effect on pulverization of pigments and poor in dispersibility.

At present, there is still not provided an excellent hydrophobic dispersion composition with improvements in the dispersibility and fluidity of a hydrophobic dispersion of pigments, etc. or a coated paper support (coated paper) formed by using the same.

### SUMMARY OF THE INVENTION

To solve problems in the related art described above, the present invention achieves the following objects.

An object of the invention is to provide a coated paper support (coated paper) formed from a hydrophobic dispersion of pigments, latex, etc. realizing stable and uniform dispersibility and fluidity without flocculating the hydrophobic dispersion.

Another object of the invention is to provide a coated paper support comprising a paper support endowed with various functions such as water resistance, gloss, toner image-receiving properties, high resolution, gas barrier properties, curling resistance and coating strength.

To solve the problems described above, the inventors made extensive study, and as a result, they found that a compound having a specific molecular structure shown below is effective for preventing flocculation of a hydrophobic dispersion and stably maintaining it in a uniformly dispersed state, and the invention was thereby completed.

The objects of the invention are achieved by providing the following resin-coated paper support.

A first aspect of the invention provides a resin-coated paper support comprising a resin coating layer on a paper support, wherein the resin coating layer comprises a water-soluble polymer having a hydrophobic group at a terminal thereof, and a hydrophobic dispersion.

A second aspect of the invention provides a resin-coated paper support according to the first aspect, wherein the hydrophobic dispersion is at least one selected from the group consisting of (1) at least one kind of dispersion selected from a pigment, a latex, an emulsion and a wax, (2) a solid dispersion of a functional water-insoluble low-molecular compound and (3) microcapsules.

A third aspect of the invention provides a resin-coated paper support according to the first or second aspect, wherein the water-soluble polymer having a hydrophobic group at a terminal is a compound represented by general formula (I):

R—X(Y)ₙ—N General formula (I)

wherein R represents a hydrophobic group or a hydrophobic polymer, X represents a divalent linking group having a hetero linkage, Y contains at least one of structural units represented by A, C and D shown below and simultaneously contains, in an amount of 0 to 40 mol %, a structural unit represented by B shown below, and n is an integer from 2 to 3500,

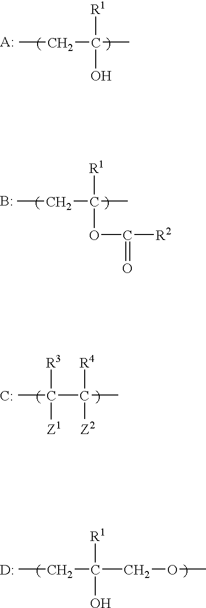

wherein R¹ represents one of a hydrogen atom and an alkyl group having 1 to 6 carbon atoms; R² represents one of a hydrogen atom and an alkyl group having 1 to 10 carbon atoms; R³ represents one of a hydrogen atom and a methyl group; R⁴ represents one of a hydrogen atom, —CH₃, —CH₂COOH (including an ammonium salt or an alkaline metal salt) and —CN; Z¹ represents one of a hydrogen atom, —COOH which includes an ammonium salt or an alkali metal salt thereof and —CONH₂; and Z² represents one of —COOH which includes an ammonium salt or an alkali metal salt thereof, —SO₃H which includes an ammonium salt or an alkali metal salt thereof, —OSO₃H which includes an ammonium salt or an alkali metal salt thereof, —CH₂SO₃H which includes an ammonium salt or an alkali metal salt thereof, —CONHC(CH₃)₂CH₂SO₃H which includes an ammonium salt or an alkali metal salt thereof and —CONHCH₂CH₂CH₂N⁺(CH₃)₃Cl⁻.

A fourth aspect of the invention provides a resin-coated paper support according to the third aspect, wherein R is a hydrophobic group including one selected from the group consisting of a substituted or unsubstituted aliphatic group, a substituted or unsubstituted aromatic group and a substituted or unsubstituted alicyclic group.

A fifth aspect of the invention provides a resin-coated paper support according to the third aspect, wherein R is at least one kind of hydrophobic polymer selected from polystyrene, polymethacrylates, polyacrylates, polyvinyl chloride, and derivatives thereof.

### DETAILED DESCRIPTION OF THE INVENTION

Hereinafter, the resin-coated paper support (coated paper) of the present invention is described in more detail.

The resin-coated paper support of the invention is a coated paper support having a resin coating layer on a paper support, and the resin coating layer contains at least a water-soluble polymer having a hydrophobic group at a terminal and a hydrophobic dispersion, and can contain other necessary components in order to confer desired functions, depending on the object.

(Water-Soluble Polymer Having a Hydrophobic Group at a Terminal)

It is considered that the water-soluble polymer having a hydrophobic group at a terminal in the invention is present in a dispersion medium in such a state that the polymer adsorbs its hydrophobic group onto the surface of a hydrophobic dispersion of pigments, etc., and the residual water-soluble polymer moiety is directed toward the outside, thus covering the hydrophobic dispersion therewith. It is estimated that the polymer can thereby disperse the hydrophobic dispersion of pigments, etc. uniformly and stably without flocculation in the aqueous medium. As a result, a resin-coated paper support (coated paper) formed by applying the aqueous dispersion onto a substrate can have excellent characteristics in various functions such as water resistance, gloss, toner image-receiving properties, high resolution, gas barrier properties, curling resistance and coating strength.

The water-soluble polymer having a hydrophobic group at a terminal in the invention is preferably a compound represented by general formula (I):

R—X(Y)ₙ—H General formula (I)

wherein R represents a hydrophobic group or a hydrophobic polymer, X represents a divalent linking group having a hetero linkage, Y contains at least one of structural units represented by A, C and D shown below and simultaneously contains, in an amount of 0 to 40 mol %, a structural unit represented by B shown below, and n is an integer from 2 to 3500,

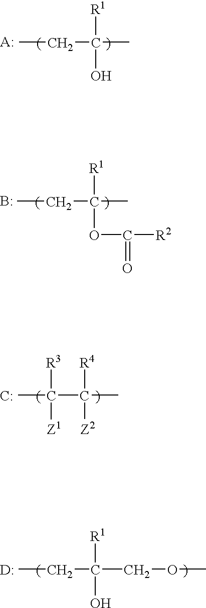

wherein R¹ represents one of a hydrogen atom and an alkyl group having 1 to 6 carbon atoms; R² represents one of a hydrogen atom and an alkyl group having 1 to 10 carbon atoms; R³ represents one of a hydrogen atom and a methyl group; R⁴ represents one of a hydrogen atom, —CH₃, —CH₂COOH (including an ammonium salt or an alkaline metal salt) and —CN; Z¹ represents one of a hydrogen atom, —COOH which includes an ammonium salt or an alkali metal salt thereof and —CONH₂; and Z² represents one of —COOH which includes an ammonium salt or an alkali metal salt thereof, —SO₃H which includes an ammonium salt or an alkali metal salt thereof, —OSO₃H which includes an ammonium salt or an alkali metal salt thereof, —CH₂SO₃H which includes an ammonium salt or an alkali metal salt thereof, —CONHC(CH₃)₂CH₂SO₃H which includes an ammonium salt or an alkali metal salt thereof and —CONHCH₂CH₂CH₂N⁺(CH₃)₃Cl⁻.

The hydrophobic group represented by R in general formula (I) is preferably an aliphatic group (for example an alkyl group, alkenyl group, alkynyl group, etc.), an aromatic group (for example a phenyl group, naphthyl group, etc.) or an alicyclic group, and these groups may further have a substituent group. The substituent group includes an aliphatic group, aromatic group, alicyclic group, heterocyclic group, halogen atom, hydroxyl group, cyano group, nitro group, N-substituted sulfamoyl group, carbamoyl group, acylamino group, alkylsulfonylamino group, arylsulfonylamino group, alkoxy group, aryloxy group, aralkyl group, acyl group, etc.

When the hydrophobic group represented by R is a substituted or unsubstituted aliphatic group, a substituted or unsubstituted aromatic group or a substituted or unsubstituted alicyclic group, the hydrophobic group can be effectively adsorbed onto the surface of a hydrophobic dispersion to further improve the affinity of the polymer with the hydrophobic dispersion, thus bringing about a higher effect of improving the stability of the hydrophobic dispersion. Among the groups described above, the substituted or unsubstituted aliphatic group is preferable, more preferably an alkyl group having 3 to 70 carbon atoms, still more preferably an alkyl group having 4 to 50 carbon atoms, and further more preferably an alkyl group having 8 to 24 carbon atoms.

The hydrophobic polymer represented by R in the general formula (I) includes polystyrene and derivatives thereof, polymethacrylates (for example methyl polymethacrylate) and derivatives thereof, polyacrylates and derivatives thereof, polybutene, polyvinyl acetate, water-insoluble vinyl polymers and vinyl copolymers represented by vinyl polyversate, water-insoluble polyoxyalkylene such as polyoxypropylene and polyoxytetramethylene, and water-insoluble polymers such as polyamide and polyester. Among those described above, polystyrene and derivatives thereof, polymethacrylates and derivatives thereof, polyacrylates and derivatives thereof, and polyvinyl chloride are preferably used.

The degree of polymerization of the hydrophobic polymer is preferably 2 to 500, more preferably 2 to 200, and particularly a hydrophobic polymer having a degree of polymerization of 2 to 100 is preferable.

Preferable examples of the above-described hydrophobic group R in the general formula (I) are shown below, but the invention is not limited thereto.

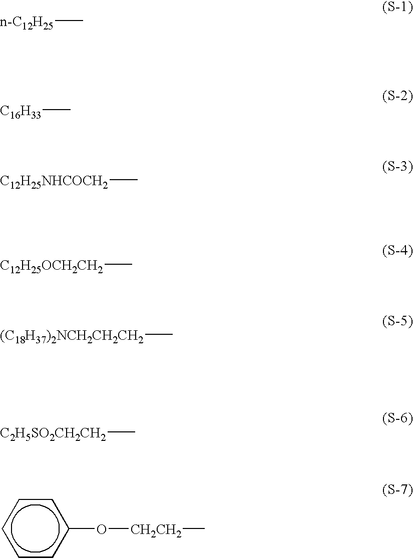

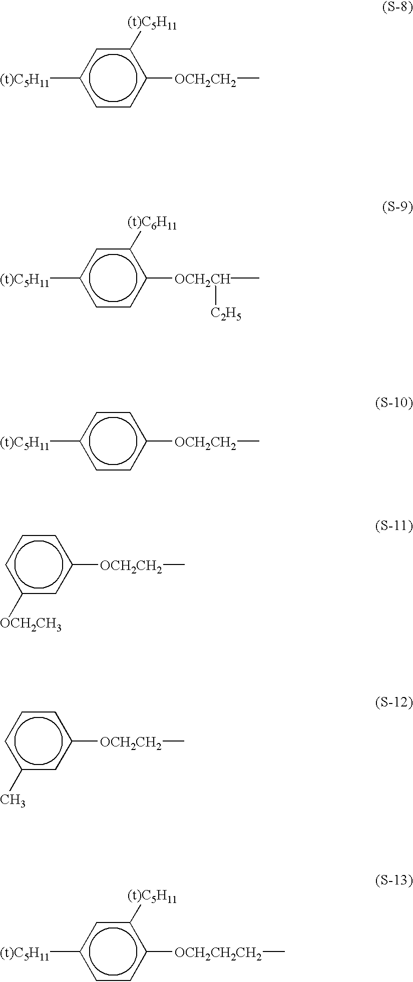

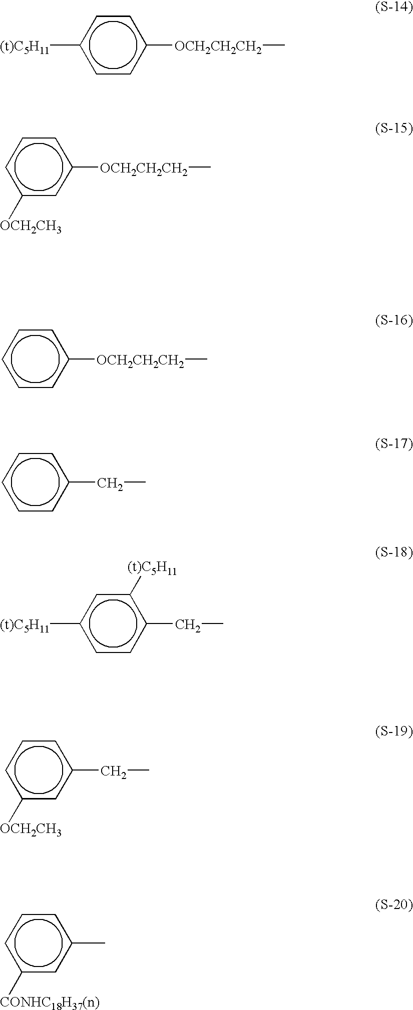

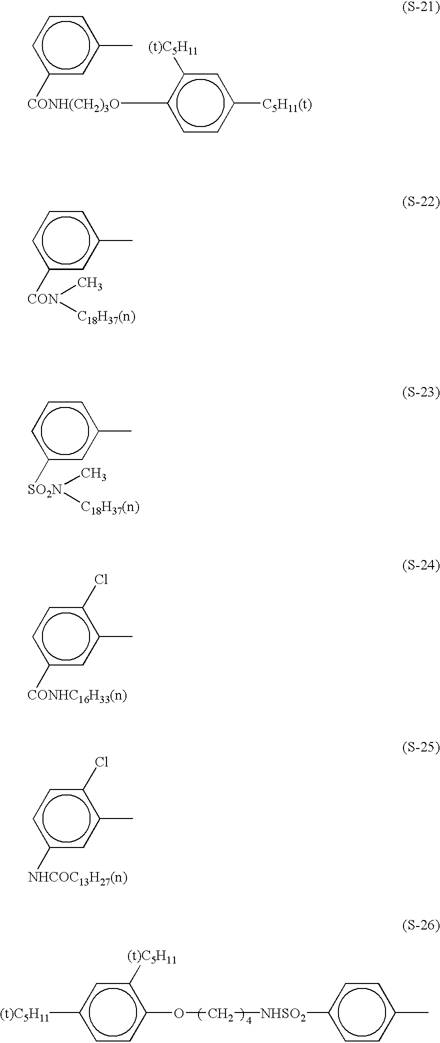

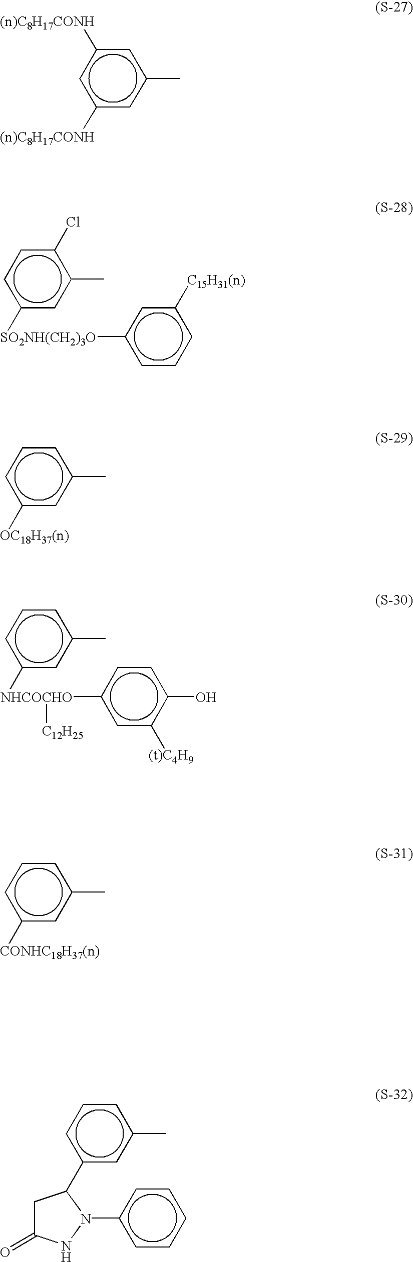

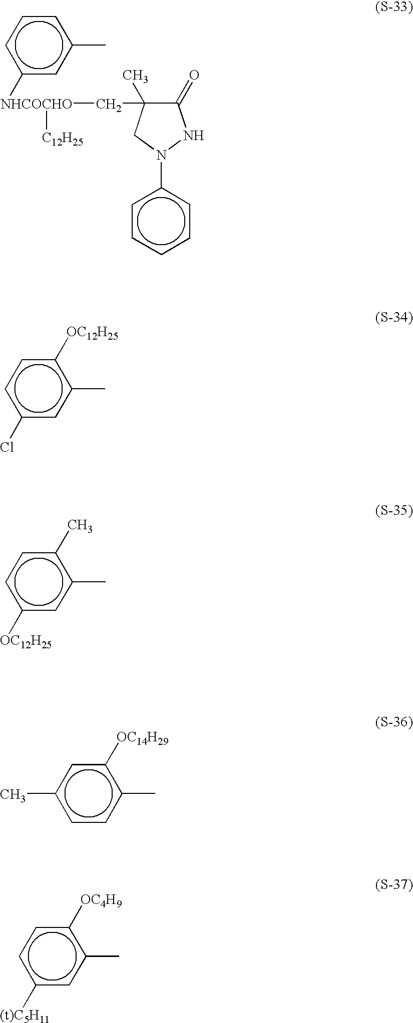

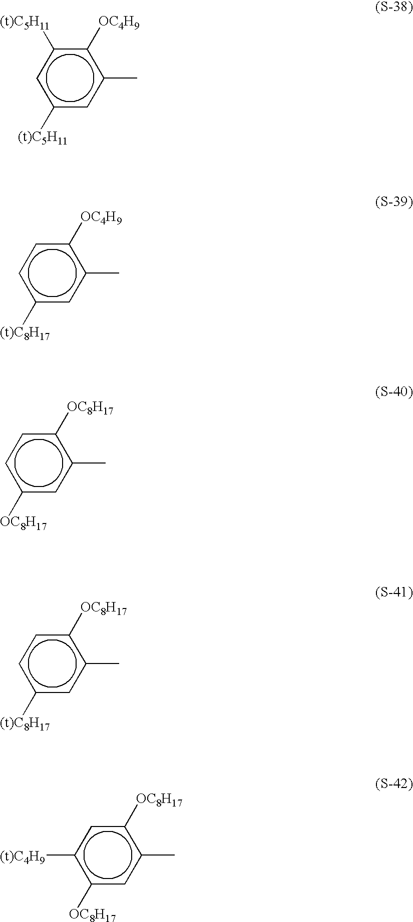

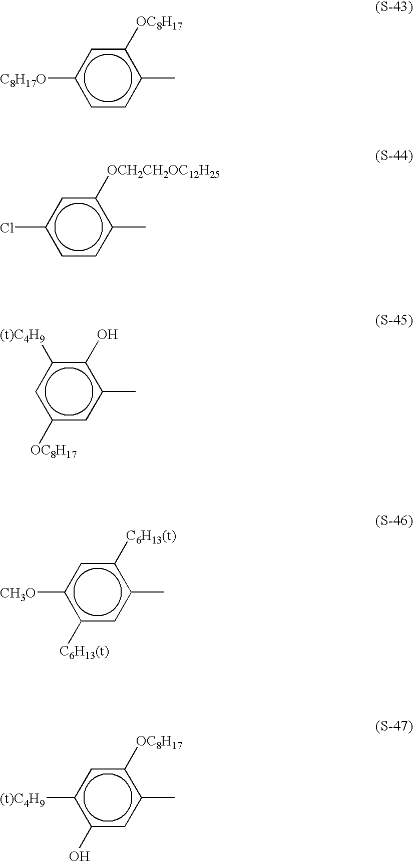

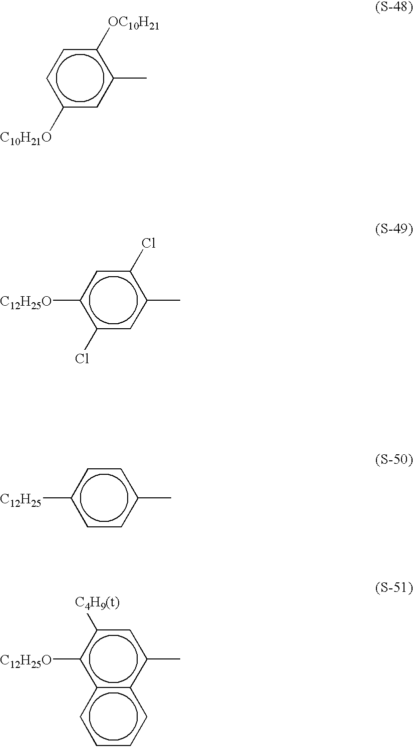

The divalent linking group having a hetero linkage, represented by the above-mentioned X in general formula (I), includes an ether linkage, ester linkage, thioether linkage, thioester linkage, sulfonyl linkage, amide linkage, imide linkage, sulfonamide linkage, urethane linkage, urea linkage, thiourea linkage, etc.

Among these linkages, the ether linkage, ester linkage, thioether linkage and thioester linkage are preferable from the viewpoint of advantageous synthesis and modification, and in particular the ether linkage, ester linkage and thioether linkage are preferable.

The above-mentioned Y in the general formula (I) contains at least one of structural units represented by the above-mentioned A, C and D and simultaneously contains, in an amount of 0 to 40 mol %, a structural unit represented by the above-mentioned B.

The lower alkyl group represented by R¹ in the structural unit A, B and D in the above-mentioned Y includes an alkyl group having 1 to 6 carbon atoms, and in particular a methyl group is preferable.

The lower alkyl group represented by R² in the structural unit B in the above-mentioned Y includes an alkyl group having 1 to 10 carbon atoms, and in particular a methyl group is preferable. The alkyl group may be substituted with a hydroxyl group, amide group, carboxyl group, sulfonate group, sulfinate group, sulfonamide group, or the like.

The above-mentioned structural unit A constituting Y includes, for example, vinyl alcohol, α-methylvinyl alcohol, α-propylvinyl alcohol, and the like.

The above-mentioned structural unit B constituting Y includes, for example, vinyl acetate, vinyl formate, vinyl propionate, and α-substituted derivatives thereof.

The above-mentioned structural unit C constituting Y includes, for example, monomer units, which dissociate into ions in water, such as acrylic acid, methacrylic acid or crotonic acid (respectively including an ammonium salt or a salt with a metal such as Na or K), maleic acid or itaconic acid (respectively including a monoalkyl ester, an ammonium salt, or a salt with a metal such as Na or K), vinylphosphonic acid, vinylsulfuric acid, acrylsulfonic acid, methacrylsulfonic acid, 2-acrylamide-3-methylpropane sulfonic acid or 2-methacrylamide-3-methylpropane sulfonic acid (respectively including an ammonium salt or a salt with a metal such as Na or K) and acrylamide propyl trimethyl ammonium chloride or methacrylamide propyl trimethyl ammonium chloride.

The above-structural unit D constituting Y includes, for example, monomer subunits such as —CH₂CH(OH)CH₂O—, —CH₂C(CH₃)(OH)CH₂O— and —CH₂C(C₂H₅)(OH)CH₂O—.

Among the above-mentioned structural units, preferably the structural unit A is vinyl alcohol, the structural unit B is vinyl acetate, the structural unit C is a vinyl monomer including carboxylic acid (including an ammonium salt or a salt with a metal such as Na or K) or a vinyl monomer including sulfonic acid (including an ammonium salt or a salt with a metal such as Na or K), and the structural unit D is —CH₂CH(OH)CH₂O—.

Among the above-mentioned structural units, vinyl alcohol as the structural unit A and vinyl acetate as the structural unit B are more preferable, and particularly vinyl alcohol as the structural unit A is most preferable.

In addition, the degree of polymerization (n) of the above-mentioned Y in the general formula (I) is preferably from 2 to 3500, more preferably from 2 to 2000, still more preferably from 4 to 1000, further more preferably from 4 to 500, and most preferably from 8 to 300, in terms of number average polymerization degree.

If the degree of polymerization is less than 2, the solubility of the polymer may be insufficient. If it is higher than 3500, the stability of a hydrophobic dispersion of pigments, etc. may be lowered, and a resin coating layer formed by applying of the dispersion may be poor in smoothness and gloss.

The ratio of the structural units A, B, C and D constituting the water-soluble polymer moiety —(Y)ₙ— in the general formula (I) is not particularly limited, and not only a copolymer produced by copolymerizing two or more structural units in an arbitrary ratio but also a homopolymer composed of one of the structural units can be used.

The compound represented by the general formula (I) includes a broad range of water-soluble to water-dispersible compounds. Insofar as the compound is water-soluble or water-dispersible, the above-mentioned Y in the general formula (I) may contain structural units other than the structural units A, B, C and D, and other structural units include, for example, structural units such as ethylene, propylene, isobutene, acrylonitrile, acrylamide, methacrylamide, N-vinyl pyrrolidone, vinyl chloride and vinyl fluoride.

The optimum chemical composition and molecular weight of the hydrophobic segment (R) and hydrophilic segment (Y) constituting the compound represented by general formula (I) are varied depending on its intended purpose, but for any purposes, the ratio of R to Y by mass is selected preferably such that 0.001≦R/Y≦2, particularly preferably 0.01≦R/Y≦1 for the effect of the compound on dispersion stability.

Preferable examples of the compound represented by the general formula (I) are cited in Tables 1 and 2 below (exemplary compounds P-1 to P-18) wherein R, X, and Y (structural units A, B, C and D) and the degree of polymerization (n) of Y in the general formula (I) are shown, but the invention is not limited thereto. R, X, Y, A, B, C, D and n in Tables 1 and 2 are as described in the general formula (I) above.

TABLE 1

| | | | Y | | |
|---|---|---|---|---|---|
| Compound No. | R | X | A | B | C, mol % |
| P-1 | S-1 | —S— | 98 mol % | 2 mol % | |
| P-2 | S-1 | —S— | 88 | 12 | |
| P-3 | S-1 | —S— | 98 | 2 | |
| P-4 | n.C₄H₉— | —S— | 90 | 10 | |
| P-5 | t.C₈H₁₇— | —S— | 88 | 12 | |
| P-6 | n.C₃₀H₆₁— | —S— | 88 | 12 | |
| P-7 | n.C₁₈H₃₇— | —S— | 98 | 2 | |
| P-8 | C₁₂H₂₅(branched)- | —S— | 98 | 2 | |
| P-9 | polymethyl methacrylate | —S— | 94.5 | 2.5 | —(—CH₂—CH(CONHC(CH₃)₂—CH₂SO₃Na)—)—, 3 |
| P-10 | polystyrene | —S— | 93.6 | 1.4 | —(—CH₂—CH(COONa)—)—, 5 |
| P-11 | polyoxypropylene | —S— | 79.1 | 15.9 | —(—CH₂—C(CH₂COONa)(COONa)—)—, 5 |
| P-12 | polystyrene | —S— | 89.7 | 0.3 | —(—CH₂—C(CH₂COONa)(COONa)—)—, 10 |

A) —(—CH₂—CH(OH)—)—
B) —(—CH₂—CH(OCOCH₃)—)—

TABLE 2

| Com- | | | |
|---|---|---|---|
| pound | | | Y |
| No. | R | X | (degree of polymerization) |
| P-13 | S-1 | 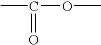 | 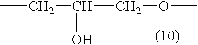 |
| P-14 | C₈H₁₇— | 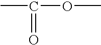 | 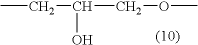 |
| P-15 | C₁₀H₂₁— | 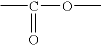 | 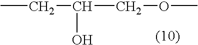 |
| P-16 | C₁₈H₃₇— | 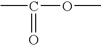 | 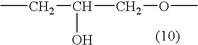 |
| P-17 | S-1 | 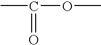 | 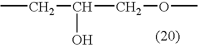 |
| P-18 | S-1 | —O— | 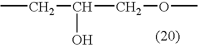 |

The compound represented by the general formula (I) can be easily synthesized by methods described in e.g. JP-A Nos. 62-288643, 61-254237, 61-254238, 61-254239 and 61-254240. If R in the general formula (I) is an alkyl group, the compound of general formula (I) can be obtained as MP-103, MP-203, MP102 and the like. manufactured by Kuraray Co., Ltd.

The amount of the compound represented by general formula (I) in the invention is preferably 1 to 50% by mass, more preferably 3 to 30% by mass, and still more preferably 5 to 20% by mass, based on the amount of the hydrophobic dispersion (pigment, etc.) used. If the amount of the compound used is less than 1% by mass, the compound cannot be sufficiently adsorbed onto the surface of the hydrophobic dispersion and thus the hydrophobic dispersion may be flocculated, while if the amount is higher than 50% by mass, the physical properties of the resulting resin-coated paper (coated paper) may be adversely affected thus failing to exhibit desired functions.

(Hydrophobic Dispersion)

The resin coating layer (coating layer) in the resin-coated paper support of the invention contains a hydrophobic dispersion together with the water-soluble polymer having a hydrophobic group at a terminal.

The hydrophobic dispersion can be selected from organic and inorganic dispersions, according to the object of the resin-coated paper support of the invention, that is, depending on functional properties to be conferred. Such hydrophobic dispersions include, for example, (1) at least one kind of dispersion selected from a pigment, a latex, an emulsion and a wax, (2) a solid dispersion of a functional water-insoluble low-molecular compound, and (3) microcapsules.

Generally, the pigment is roughly divided into an organic pigment and an inorganic pigment. The organic pigment is generally excellent in transparency, while the inorganic pigment is excellent in shielding and the like, so either pigment may be selected as necessary. Besides, metal powder, fluorescent pigments and the like may be used in some cases.

The inorganic pigment include, for example, titanium dioxide, barium sulfate, lithopone, aluminum oxide, calcium carbonate, silicon oxide, antimony trioxide, titanium phosphate, zinc oxide, white lead and zirconium oxide. Among these pigments, use of titanium dioxide is particularly effective for conferring whiteness, shielding and gloss. Titanium dioxide may be a rutile or anatase type. In pursuit of whiteness, the anatase type is preferable and in pursuit of sharpness, the rutile type is preferable. Both of the rutile and anatase types may be blended in pursuit of both whiteness and sharpness. When the resin coating layer (coating layer) is composed of many layers, it is preferable to use a method in which the anatase type is used in some layers, while the rutile type is used in other layers. The titanium dioxide may be produced by either a sulfate method or a chloride method.

Examples of the organic pigment include azo-based pigments, phthalocyanine-based pigments, anthraquinone-based pigments, dioxazine-based pigments, quinacridone-based pigments, isoindolinone-based pigments, nitro-based pigments. Examples of the organic pigments classified depending on shade are listed below, but the invention is not limited thereto.

(1) The yellow pigment includes hansa yellow G, hansa yellow 5G, hansa yellow 10G, hansa yellow A, pigment yellow L, permanent yellow NCG, permanent yellow FGL, permanent yellow HR and the like.

(2) The red pigment includes permanent red 4R, permanent red F2R, permanent red FRL, lake red C, lake red D, pigment scarlet 3B, bordeau 5B, alizarin lake, rhodamine lake B and the like.

(3) The blue pigment includes phthalocyanine blue, Victoria blue lake, fast sky blue and the like.

(4) The black pigment includes carbon black and the like.

The functional water-insoluble low-molecular compound described above includes ultraviolet ray absorbents, brightening agents, organic or inorganic coloring dyes or pigments, and dispersing oils.

The ultraviolet ray absorbent suitable for carrying out the invention is described in e.g. JP-B Nos. 42-21687, 48-5496, JP-A No. 47-1026, U.K. Patent No. 1293982, etc. Among those described, oil-soluble ultraviolet ray absorbents are preferable.

The dye or pigment used in the invention includes organic dye of pigment or inorganic dye of pigment such as azo, azomethine, oxonol, cyanine, phthalocyanine, quinacridone, anthraquinone, dioxazine, indigo, perinone-perylene, titanium oxide, cadmium, iron oxide, chrome oxide and carbon black, and in addition, known dyes or mixtures thereof conventionally used as coloring matters can be used. The dye and pigment in the invention can be used in any form such as an aqueous paste form and a powdery form just after production. The invention is useful particularly for dispersion of oil-soluble dyes described in U.S. Pat. No. 4,420,555, JP-A Nos. 61-204630, 61-205934, etc.

Particularly useful oil-soluble dyes in the invention are described below.

The particularly useful oil-soluble dyes in the invention may be any known dyes. These dyes include an arylidene compound, a heterocyclic arylidene compound, anthraquinone or a derivative thereof, triarylmethane or a derivative thereof, azomethine dye, azo dye, cyanine, melocyanine, oxonol, styryl dye, phthalocyanine, indigo, etc. Preferably, the dye used in the invention is insoluble in water, and the solubility thereof in ethyl acetate is at least 10 g/L (40° C.), and the structure of its chromophore is not important.

The arylidene compound is a compound having an acidic nucleus and an aryl group linked via one or more methine groups.

The acidic nucleus includes 2-pyrazolin-5-one, 2-isooxazolin-5-one, barbituric acid, 2-thiobarbituric acid, benzoyl acetonitrile, cyanoacetamide, cyanoacetanilide, cyanoacetate, malonate, malonedianilide, dimedone, benzoyl acetanilide, pivaloyl acetanilide, malononitrile, 1,2-dihydro-6-hydroxypyridin-2-one, pyrazolidine-3,5-dione, pyrazolo[3,4-b]pyridine-3,6-dione, indane-1,3-dione, hydantoin, thiohydantoin, 2,5-dihydro-furan-2-one and the like.

The aryl group includes a phenyl group which is preferably substituted with an electron-donating group such as an alkoxy group, hydroxy group and amino group.

The heterocyclic arylidene compound is a compound having an acidic nucleus and a hetero-aromatic ring linked via one or more methine groups. The acidic nucleus includes those described above. The hetero-aromatic ring includes pyrrole, indole, furan, thiophene, pyrazol coumarin and the like.

The anthraquinone derivative is a compound having anthraquinone substituted with an electron-donating group or an electron-withdrawing group.

The triaryl methane derivative is a compound having three substituted aryl groups (which may be the same or different) added to one methine group. An example thereof is phenolphthalein.

The azomethine dye is a compound having an acidic nucleus and an aryl group linked via an unsaturated nitrogen linking group (azomethine group). The acidic nucleus includes conventional photographic couplers in addition to those described above. The indoaniline derivative also belongs to the azomethine dye.

The azo dye is a compound having an aryl group or a hetero-aromatic cyclic group linked via an azo group.

Cyanine is a compound having two basic nuclei linked via one or more methine groups. The basic nuclei include pyrylium and quaternary salts of oxazole, benzoxazole, thiazole, benzothiazole, benzoimidazole, quinoline, pyridine, indolenine, benzoindolenine, benzoselenazole and imidazoquinoxaline.

The melocyanine dye is a compound having the basic nucleus and acidic nucleus linked via a double bond or via one or more methine groups.

The oxonol dye is a compound having the 2 acidic nuclei linked via one or three or more, odd methine groups.

The styryl dye is a compound having the basic nucleus and an aryl group linked via two or four methine groups.

Phthalocyanine may or may not be coordinated with a metal.

Indigo may be substituted or unsubstituted indigo including thioindigo.

The high-boiling organic substance (dispersing oil) used in suppressing crystallization upon dispersing the water-insoluble compound finely in an aqueous medium is preferably the one substantially insoluble in water and having a boiling point of 190° C. or more at ordinary pressures. Incorporation of an emulsified dispersion of the high-boiling organic substance (dispersing oil) may be required for various purposes such as regulation of the elasticity of a film constituting a photographic element, capture of an oil-soluble substance, and regulation of adhesion or adhesiveness. This type of organic substance can be selected from carboxylates, phosphates, carboxylic acid amides, ethers, phenols, anilines, substituted hydrocarbons and surface-inactive hydrophobic organic polymers.

Examples thereof include di-n-butyl phthalate, diisooctyl phthalate, dicyclohexyl phthalate, dimethoxyethyl phthalate, di-n-butyl adipate, diisooctyl azelate, tri-n-butyl citrate, butyl laurate, di-n-butyl sebacate, tricyclohexyl phosphate, tri-n-butyl phosphate, triisooctyl phosphate, N,N-diethylcaprylic acid amide, N,N-dimethylpalmitic acid amide, n-butyl-(m-pentadecyl)phenyl ether, ethyl-(2,4-di-tert-butyl)phenyl ether, 2,5-di-tert-aminophenol, 2-n-butoxy-5-tert-octylaniline, chlorinated paraffin, poly(ethyl methacrylate), poly(ethyl acrylate), poly(ethyl acrylate), poly(cyclohexyl methacrylate), poly(N-tert-butylacrylamide), poly(N-tert-octylacrylamide) and the like.

In addition to the high-boiling organic substance, a water-immiscible low-boiling organic solvent (having a boiling point of 130° C. or less at 1 atmospheric pressure) or a water-miscible organic solvent may be used in the invention in order to dissolve the water-insoluble compound. To improve the stability of the resulting dispersion, a water-immiscible low-boiling organic solvent or a water-miscible organic solvent used for making a solution of a photographically useful substance may be removed by distillation, more preferably distillation under reduced pressure or ultrafiltration or any other known methods.

These organic solvents include, for example, propylene carbonate, methyl acetate, ethyl acetate, isopropyl acetate, butyl acetate, ethyl propionate, sec-butyl alcohol, methyl ethyl ketone, 2-pentanone, 3-pentanone, cyclohexanone, dimethylformamide, dimethosulfoxide and the like. The ratio by mass of the organic solvent to be used is preferably 0.1 to 100 to the water-insoluble compound to be dispersed.

In the invention, various brightening agents can be used to improve whiteness. The generally used brightening agents include 4,4′-diaminostilbene-based agents described in JP-A No. 57-58651 and U.S. Pat. No. 3,269,840 as well as compounds descried in “Keiko Zohakuzai” (Fluorescent Whiteners) (published in 1976) compiled by KASEIHIN KOGYO KYOKAI, JP, “Senryo Binran” (Dye Handbook) compiled by Society of Synthetic Organic Chemistry, Japan (published in 1970 by Maruzen Co., Ltd.), JP-B Nos. 46-35240, 49-20975 and JP-A No. 59-49537.

One brightening agent may be added, or two or more agents may be simultaneously used.

The latex dispersion includes polymer latex.

The polymer constituting the polymer latex to be used in the invention includes, for example, acrylates, methacrylates, crotonates, vinyl esters, malate diesters, fumarate diesters, itaconate diesters, acrylamides, methacrylamides, vinyl ethers and styrenes.

Among these monomers, the acrylates include, for example, methyl acrylate, ethyl acrylate, n-propyl acrylate, isopropyl acrylate, n-butyl acrylate, isobutyl acrylate, tert-butyl acrylate, hexyl acrylate, 2-ethylhexyl acrylate, acetoxyethyl acrylate, phenyl acrylate, 2-methoxy acrylate, 2-ethoxy acrylate, 2-(2-methoxyethoxy)ethyl acrylate and the like. The methacrylates include methyl methacrylate, ethyl methacrylate, n-propyl methacrylate, n-butyl methacrylate, tert-butyl methacrylate, cyclohexyl methacrylate, 2-hydroxyethyl methacrylate, 2-ethoxyethyl methacrylate and the like. The crotonates include butyl crotonate, hexyl crotonate and the like. The vinyl esters include vinyl acetate, vinyl propionate, vinyl butyrate, vinylmethoxy acetate, vinyl benzoate and the like. The maleate diesters include diethyl maleate, dimethyl maleate, dibutyl maleate and the like. The fumarate diesters include diethyl fumarate, dimethyl fumarate, dibutyl fumarate and the like. The itaconate diesters include diethyl itaconate, dimethyl itaconate, dibutyl itaconate and the like.

The acrylamides include acrylamide, methyl acrylamide, ethyl acrylamide, propyl acrylamide, n-butyl acrylamide, tert-butyl acrylamide, cyclohexyl acrylamide, 2-methoxyethyl acrylamide, dimethyl acrylamide, diethyl acrylamide, phenyl acrylamide and the like. The methacrylamides include methyl methacrylamide, ethyl methaacrylamide, n-butyl methacrylamide, tert-butyl methacrylamide, 2-methoxy methacrylamide, dimethyl methacrylamide, diethyl methacrylamide and the like. The vinyl ethers include methyl vinyl ether, butyl vinyl ether, hexyl vinyl ether, methoxy ethyl vinyl ether, dimethyl aminoethyl vinyl ether and the like. The styrenes include styrene, methyl styrene, dimethyl styrene, trimethyl styrene, ethyl styrene, isopropyl styrene, butyl styrene, chloromethyl styrene, methoxy styrene, butoxy styrene, acetoxy styrene, chlorostyrene, dichlorostyrene, bromostyrene, methyl vinylbenzoate, 2-methyl styrene and the like.

The polymer composed of these monomers may be a homopolymer or copolymer. Binary or ternary copolymers composed of acrylate, methacrylate, styrene, acrylic acid and/or methacrylic acid, styrene/butadiene copolymers, or polyvinylidene chloride are preferably used.

When the resin-coated paper support is used as an ink jet recording paper, a dye scavenger is integrated in the resin coating layer.

The scavenger used in these applications includes water-soluble polymer mordants, oil-soluble polymer mordants and polymer latex mordants, among which the polymer latex mordants are preferably used.

The polymer mordant is a polymer containing a tertiary amino group, a polymer having a nitrogen-containing heterocyclic moiety, and a polymer containing a quaternary cationic group thereof. Further, a polymer mordant containing imidazole or a derivative thereof is highly lightfast and preferably used.

The polymer containing a vinyl monomer unit having a tertiary amino group is described in JP-A Nos. 60-60643, 60-57836, etc., and the polymer containing a vinyl monomer unit having a tertiary imidazole group is described specifically in JP-A Nos. 60-118834, 60-122941, Japanese Patent Application No. 61-87180, 61-87181, U.S. Pat. Nos. 4,282,305, 4,115,124, 3,148,061 and the like.

The polymer containing a vinyl monomer unit having a quaternary imidazolium salt is described specifically in U.K. Patent Nos. 2,056,101, 2,093,041, 1,594,961, U.S. Pat. Nos. 4,124,386, 4,115,124, 4,273,853, 4,450,224, JP-A No. 48-28225, etc.

Other polymers containing a vinyl monomer unit having a quaternary ammonium salt are described specifically in U.S. Pat. No. 3,709,690, 3,898,088, 3,958,995, JP-A Nos. 60-57836, 60-60643, 60-122940, 60-122942 and 60-235134.

Free radical polymerization of ethylenically unsaturated solid monomers is initiated by addition of free radicals to the monomer molecules, in which the free radicals are formed by thermal decomposition of a chemical initiator, by the action of a reducing agent (redox initiator) on an oxidizing compound, or by physical actions such as UV rays or high-energy irradiation, high frequency, etc.

Major chemical initiators include persulfates (ammonium and potassium persulfates), hydrogen peroxide and 4,4′-azobis(4-cyanovalerianic acid), each of which is water-soluble. Major chemical initiators also include azoisobutyronitrile, benzoyl peroxide, chlorobenzoyl peroxide and other compounds, each of which is water-insoluble.

The conventional redox initiator includes hydrogen peroxide-iron (II) salt, potassium persulfate-potassium bisulfate, and cerium salt alcohol.

Examples of the initiator and its action are described by F. A. Bovey in Emulsion Polymerization, pp. 59-93, 1955, Interscience Publishes Inc. New York.

As the emulsifier, a surface-active compound is used, and preferable examples include soaps, sulfonates, sulfates, cationic compounds, amphoteric compounds and polymeric protective colloids. Examples of these groups and their action are described in Belgische Chemische Industrie, vol.28, pp.16-20 (1963).

Examples of the polymer latex which can be used in the invention are described below, but the invention is not limited thereto.

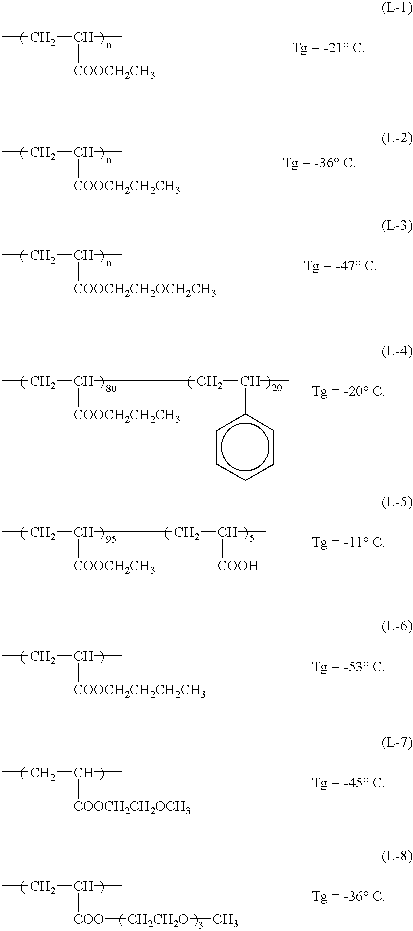

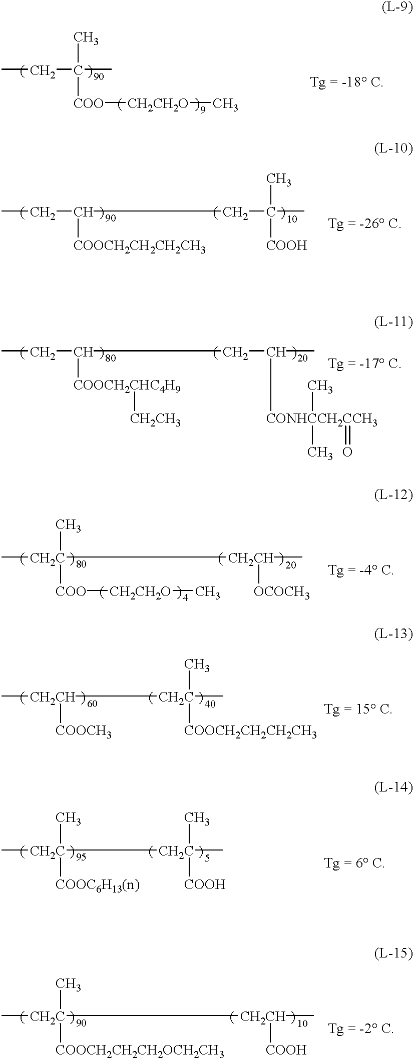

(The degree of copolymerization is expressed in mol %.)

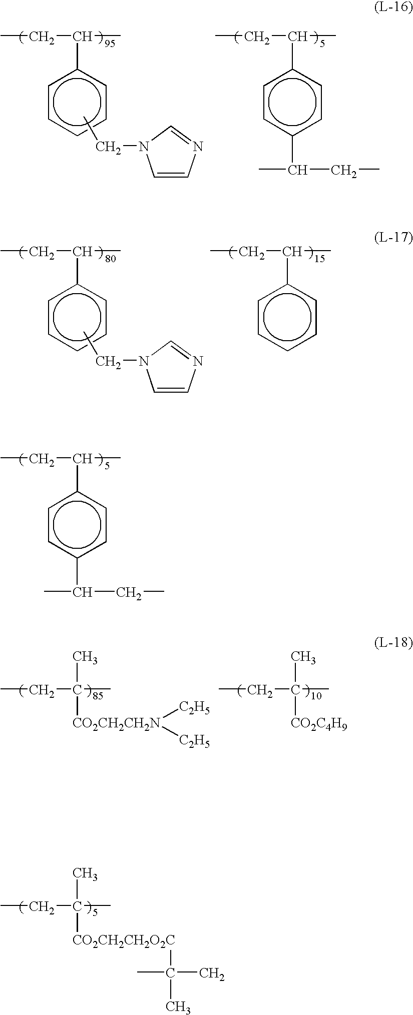

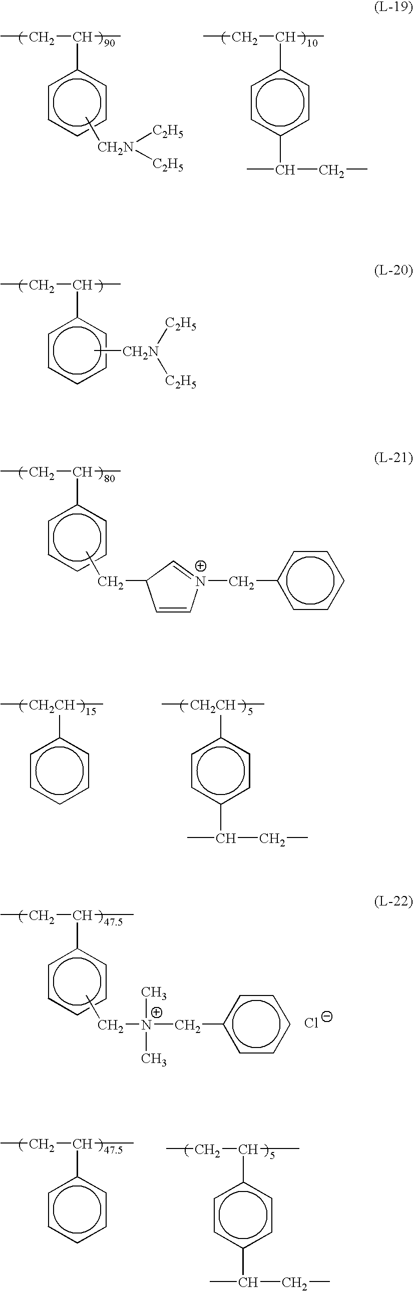

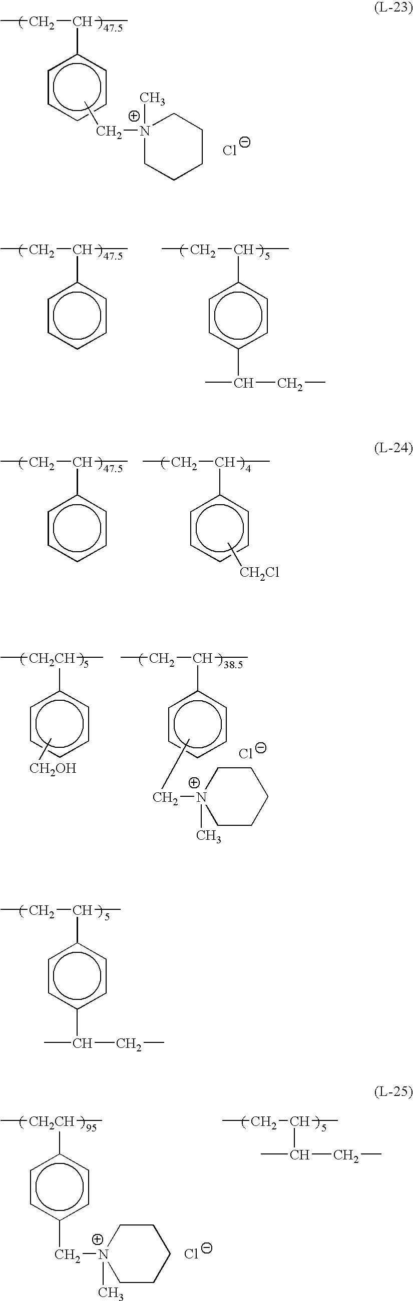

The wax is preferably solid at ordinary temperatures and is preferably a compound having a melting point in the range of 30 to 200° C., particularly 50 to 150° C., and both natural and synthetic waxes are preferable.

The natural wax includes, for example, vegetable waxes such as carnauba wax and Japan wax; animal waxes such as beeswax; mineral waxes such as montan wax; petroleum-based waxes such as paraffin wax and microcrystalline wax; higher fatty acid metal salts, higher fatty amides, higher fatty acids, higher fatty esters and C₂₀₋₃₆ fatty hydrocarbons. Among these, the higher fatty acid metal salts include higher fatty acid alkali metal salts, alkaline earth metal salts, zinc salts and aluminum salts.

The synthetic wax includes, for example, synthetic hydrocarbon-based wax such as polyethylene wax; modified wax such as montan wax derivatives and paraffin wax derivatives; hydrogenated wax such as hardened castor oil; montanate wax, zinc stearate, stearic acid amide, methylol stearic acid amide, ethylene bistearic acid amide, polyethylene/ethoxylated alcohol block polymers (for example, Unitox (trade name), manufactured by Toyo Petrolite), tristeallyl phosphate, etc.

The microcapsules include microcapsules having brightening agents, ultraviolet ray absorbents, coloring dyes, etc. encapsulated therein.

The content of the hydrophobic dispersion in the resin coating layer (coating layer) of the invention is selected suitably depending on desired functions, and in the conventional coated paper, the content is suitably 5 to 40% by mass, preferably 7 to 25% by mass. This range is preferable because if the content of the hydrophobic dispersion is less than 5% by mass, the coating layer may hardly achieve necessary whiteness and resolution, while if the content is higher than 45% by mass, the coating layer may be cracked.

The aqueous medium for dispersing the hydrophobic dispersion of pigments, etc. in the invention is a solvent based on water, and if necessary, another solvent such as alcohol compatible with water, or a solvent to which various salts and additives were added, may be used in such a range that the effect of the invention is not deteriorated.

The method for dispersing the hydrophobic dispersion of the invention in the aqueous medium can be selected suitably from known dispersing methods. For example, a dispersing method by a high-speed stirrer, such as an ultrasonic dispersing machine, a dissolver, a homomixer, a homogenizer and a homo-blender is suitable.

To improve the affinity of the hydrophobic dispersion of pigments and the like with the water-soluble polymer having a hydrophobic group at a terminal, a wide variety of generally known dispersion improving agent such as a wetting agent can also be added.

For application to an ink jet recording paper or a thermal transfer recording image-receiving paper, any material added to the image-recording side of the water-resistant resin coating layer may be added. For an application of an image-recording material, on which an image is formed by a heat-sensitive system, an electrostatic toner system, a laser system, or the like, any material added to the image-recording side of the water-resistant resin coating layer may be added.

(Substrate for the Paper Support)

The basic constitution of the paper support used in the invention will now be described.

The base paper used in the paper support of the invention is produced from wood pulp as a main material. As the wood pulp, both conifer pulp and broadleaf tree pulp can be used, but broadleaf tree pulp of short fibers is used preferably in a higher ratio. Specifically, broadleaf tree pulp is used preferably in an amount of 60% or more in the pulp constituting the base paper.

If necessary, a part of wood pulp may be replaced by synthetic pulp made of e.g. polyethylene and polypropylene or synthetic fibers made of e.g. polyester, polyvinyl alcohol and nylon.

The overall freeness of the used pulp is preferably 150 to 500 mL, and more preferably 200 to 400 mL, in CSF standards. The fiber length after beating is selected preferably such that the amount of 24+42 mesh residues determined in JIS P8207 is not higher than 40% by mass.

A general sizing agent is internally added to the base paper, and use of neutral sizing agents made of e.g. epoxylated fatty acid amides, fatty acid anhydrides, rhodinic anhydride, alkenyl succinic anhydride, succinic acid amide, isopropenyl stearate, aziridine compounds or alkyl ketene dimers is preferable in the invention.

A fixing agent for the sizing agent is internally added generally to the base paper, and it is preferable in the invention that a sulfate band (aluminum sulfate) usually used as a fixing agent or a neutral or weakly alkaline compound such as cationated starch, polyamide polyamine epichlorohydrin, polyacrylamide or a polyacrylamide derivative is used, and that after the sulfate band is added, it is neutralized with an alkali.

For the purpose of improving smoothness, the base paper may be compounded with fillers such as calcium carbonate, talc, clay, kaolin, titanium dioxide, fine particles of urea resin.

If necessary, paper-strength enhancers such as polyacrylamide, starch or polyvinyl alcohol; softeners such as a reaction product of a maleic anhydride copolymer with polyalkylene polyamine, a quaternary ammonium salt of higher fatty acid and the like; chromatic dyes; and fluorescence dyes may be added to the base paper as internal additive chemicals other than the sizing agent, fixing agent and fillers.

The base paper used in the paper support of the invention can be produced from the above-described starting materials by ford linear machine or jet homer.

The basis weight of the base paper is preferably 20 to 300 g/m², and more preferably 50 to 200 g/m². The thickness of the base paper is preferably 25 to 350 μm, and more preferably 40 to 250 μm.

### EXAMPLES

Hereinafter, the present invention is described by reference to the Examples, but the invention is not limited to the Examples. Unless otherwise specified, “parts” refers to “parts by mass” and “%” to “% by mass”.

### Example 1

(Production of a Base Paper)

Wood pulp composed of 100 parts of LBKP/NBS=80/20 (ratio by mass) was beaten with a double disk refiner to a Canadian freeness of 300 cc, and 1 part of sodium stearate, 1.0 part of anion polyacrylamide, 1.5 parts of aluminum chloride, and 0.3 part of polyamide polyamine epichlorohydrin, all of which are expressed in terms of the ratio thereof on an absolutely dry weight basis to the pulp, were added to the pulp and then formed with ford linear machine into a base paper having a basis weight of 180 g/m² which was then subjected to machine calendering (metal roll temperature 220° C., nip pressure 300 kg/cm) to produce a highly smooth base paper.

(Preparation of a Titanium Oxide Dispersion)

26 parts of water and 0.5 part of 25% aqueous solution of Demol EP (Kao Corporation) were added to 33 parts of 15% aqueous solution of PVA205 (Kuraray Co., Ltd.), and 40 parts of Tiepeek R780-2 (Ishihara Sangyo Kaisha, Ltd.) were added to the mixture under stirring, to prepare a crude dispersion.

This crude dispersion was crushed and finely dispersed with glass beads having an average particle diameter of 2.0 mm by Dynomill KDL (Shinmaru Enterprises Corporation) to prepare a titanium oxide dispersion. The average particle diameter of the resulting dispersion, as measured with a particle diameter distribution measuring unit LA-700 (Horiba, Ltd.), was 0.32 μm in terms of median diameter.

(Production of a Coated Paper)

A coating solution with the composition shown below was applied onto the base paper in such an amount as to form a dry coating of 15 g/m² in thickness, and the coating was dried at 90° C. and then subjected to soft calendering (metal roll temperature 80° C., nip pressure 80 kg/cm), to produce a polymer coated paper (A).

<Composition of the coating solution>

| | |
|---|---|
| Nipol LX407AS | 100 parts |
| (48%, manufactured by Zeon Corporation) | |
| MP103 (10%, manufactured by Kuraray Co., Ltd.) | 40 parts |
| The titanium oxide dispersion (40%) | 25 parts |

“MP103” is polyvinyl alcohol (PVA) having a —S—C₁₂H₂₅ group at a terminal of PVA having a saponification degree of 98% and a polymerization degree of 300, and the composition is as shown in the exemplary compound (P-1) in Table 1.

### Example 2

The polymer coated papers (B to G) in Examples 1 to 5 and Comparative Examples 1 to 2 were produced in the same manner as in Example 1 except that latexes and dispersants shown in Table 3 were used in place of Nipol LX407AS and MP103 in <Composition of the coating solution> in Example 1.

TABLE 3

| | Coated paper | Latex | Dispersant | Pigment |
|---|---|---|---|---|
| Example 1 | A (Invention) | Nipol LX4O7AS | MP103 | TiO₂ |
| | | (Zeon Corporation) | (P-1) | |
| Example 2 | B (Invention) | Nipol LX407AS | PGLE-ML10 | TiO₂ |
| | | (Zeon Corporation) | (P-13) | |
| Example 3 | C (Invention) | Nipol SX1706 | MP103 | TiO₂ |
| | | (Zeon Corporation) | (P-1) | |
| Example 4 | D (Invention) | Nipol SX1706 | PGLE-ML10 | TiO₂ |
| | | (Zeon Corporation) | (P-13) | |
| Example 5 | E (Invention) | Aquablid AU304 | PGLE-ML10 | TiO₂ |
| | | (Daicel Chemical | (P-13) | |
| | | Industries, Ltd.) | | |
| Compar- | F | Nipol LX407AS | None | TiO₂ |
| ative | (Comparative | (Zeon Corporation) | | |
| Example 1 | Example) | | | |
| Compar- | G | Nipol LX407AS | PVA205 | TiO₂ |
| ative | (Comparative | (Zeon Corporation) | | |
| Example 2 | Example) | | | |

(Evaluation Test)

The stability of the dispersion in the coating solution obtained above was evaluated by two methods shown below, and the results are shown in Table 4.

<Observation of Precipitation>

The coating solution was stored for 1 day, then observed for its precipitation and evaluated under the following criteria:

◯: no precipitation.

Δ: slight precipitation.

X: separation into two phases and appearance of a supernatant.

<Measurement of Gloss>

The gloss was determined by measuring the reflection of incident light at 45° on the mirror face by a varied-angle photometer VGS-1001DP manufactured by Nippon Denshoku Industries Co., Ltd.

TABLE 4

| | Coated paper | Precipitation | Gloss |
|---|---|---|---|
| Example 1 | A (Invention) | ◯ | 82 |
| Example 2 | B (Invention) | ◯ | 79 |
| Example 3 | C (Invention) | ◯ | 80 |
| Example 4 | D (Invention) | ◯ | 78 |
| Example 5 | E (Invention) | ◯ | 83 |
| Comparative | F (Comparative | X | 21 |
| Example 1 | Example) | | |
| Comparative | G (Comparative | X | 35 |
| Example 2 | Example) | | |

From the results in Table 4, the coating dispersions of the invention (Examples 1 to 5) containing the water-soluble polymer having a hydrophobic group at a terminal and TiO₂ pigment were stable dispersions without precipitation even after storage for 1 day. The resin-coated paper supports (coated papers) formed by using the coating solutions were excellent in gloss.

On the other hand, the dispersions in Comparative Examples 1 and 2 not containing the water-soluble polymer having a hydrophobic group at a terminal in the invention were separated into two phases after 1 day, and the resin-coated paper supports (coated papers) formed by using the coating solutions were poor in gloss.

According to the invention, there can be obtained a stable aqueous dispersion coating solution preventing flocculation of a hydrophobic dispersion of pigments and the like, and by using this dispersion to form a resin coating, there can be provided a resin-coated paper support (coated paper) excellent in various functions such as water resistance, gloss, toner image-receiving properties, high resolution, gas barrier properties, curling resistance and coating strength.

What is claimed is:

1. A resin-coated paper support comprising a resin coating layer on a paper support, wherein the resin coating layer comprises a water-soluble polymer having a hydrophobic group at a terminal thereof, and a hydrophobic dispersion.

2. A resin-coated paper support according to claim 1, wherein a base paper used in the paper support contains wood pulp as a main material thereof and comprises synthetic fibers.

3. A resin-coated paper support according to claim 1, wherein an overall freeness of the pulp used in the paper support is 150 to 500 mL in CSF standards.

4. A resin-coated paper support according to claim 1, wherein a basis weight of a base paper used in the paper support is 20 to 300 g/m².

5. A resin-coated paper support according to claim 1, wherein a thickness of a base paper used in the paper support is 25 to 350 μm.

6. A resin-coated paper support according to claim 1, wherein a content of the hydrophobic dispersion in the resin coating layer is 5 to 40% by mass.

7. A resin-coated paper support according to claim 1, wherein the hydrophobic dispersion comprises at least one selected from the group consisting of (1) at least one kind of dispersion selected from a pigment, a latex, an emulsion and a wax, (2) a solid dispersion of a functional water-insoluble low-molecular compound and (3) microcapsules.

8. A resin-coated paper support according to claim 7, wherein the functional water-insoluble low-molecular compound is an ultraviolet ray absorbent.

9. A resin-coated paper support according to claim 1, wherein the water-soluble polymer having a hydrophobic group at a terminal is a compound represented by the following general formula (I):
R—X(Y)ₙ—H General formula (I)
wherein, in general formula (I), R represents a hydrophobic group or a hydrophobic polymer; X represents a divalent linking group having a hetero linkage; Y contains at least one of structural units represented by A, C and D shown below and simultaneously contains, in an amount of 0 to 40 mol %, a structural unit represented by B shown below; and n is an integer from 2 to 3500, 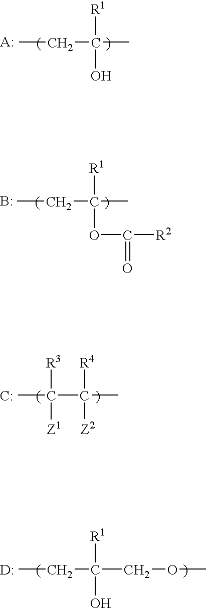
wherein R¹ represents one of a hydrogen atom and an alkyl group having 1 to 6 carbon atoms; R² represents one of a hydrogen atom and an alkyl group having 1 to 10 carbon atoms; R³ represents one of a hydrogen atom and a methyl group; R⁴ represents one of a hydrogen atom, —CH₃, —CH₂COOH which includes an ammonium salt or an alkaline metal salt thereof and —CN; Z¹ represents one of a hydrogen atom, —COOH which includes an ammonium salt or an alkali metal salt thereof and —CONH₂; and Z² represents one of —COOH which includes an ammonium salt or an alkali metal salt thereof, —SO₃H which includes an ammonium salt or an alkali metal salt thereof, —OSO₃H which includes an ammonium salt or an alkali metal salt thereof, —CH₂SO₃H which includes an ammonium salt or an alkali metal salt thereof, —CONHC(CH₃)₂CH₂SO₃H which includes an ammonium salt or an alkali metal salt thereof and —CONHCH₂CH₂CH₂N⁺(CH₃)₃Cl⁻.

10. A resin-coated paper support according to claim 9, wherein the hydrophobic dispersion comprises at least one selected from the group consisting of (1) at least one kind of dispersion selected from a pigment, a latex, an emulsion and a wax, (2) a solid dispersion of a functional water-insoluble low-molecular compound and (3) microcapsules.

11. A resin-coated paper support according to claim 9, wherein R is a hydrophobic group including one selected from the group consisting of a substituted or unsubstituted aliphatic group, a substituted or unsubstituted aromatic group and a substituted or unsubstituted alicyclic group.

12. A resin-coated paper support according to claim 9, wherein R is a hydrophobic polymer containing one selected from the group consisting of polystyrene, polymethacrylate, polyacrylate, polyvinyl chloride, and derivatives thereof.

13. A resin-coated paper support according to claim 9, wherein R is a hydrophobic polymer having a polymerization degree of 2 to 500.

14. A resin-coated paper support according to claim 9, wherein a ratio of R to Y by mass satisfies 0.001≦R/Y≦2.

15. A resin-coated paper support according to claim 9, wherein a ratio of R to Y by mass satisfies 0.01≦R/Y≦1.

16. A resin-coated paper support according to claim 9, wherein n is from 4 to 1000.

17. A resin-coated paper support according to claim 9, wherein n is from 8 to 300.

18. A resin-coated paper support according to claim 9, wherein an amount of the compound represented by the general formula (I) is 1 to 50% by mass based on an amount of the hydrophobic dispersion.

19. A resin-coated paper support according to claim 9, wherein an amount of the compound represented by the general formula (I) is 3 to 30% by mass based on an amount of the hydrophobic dispersion.

20. A resin-coated paper support according to claim 9, wherein an amount of the compound represented by the general formula (I) is 5 to 20% by mass based on an amount of the hydrophobic dispersion.
